(19) United States
(12) Patent Application Publication
(10) Pub. No.: US 2022/0269997 A1
(43) Pub. Date: Aug. 25, 2022

(54) AVIATION-BASED ENTITY RATING PLATFORM

(71) Applicant: CHIRP Technologies Inc, Toronto (CA)

(72) Inventors: Charan Kumar Bommireddipalli, Toronto (CA); Timothy Edward Ray, Etobicoke (CA)

(21) Appl. No.: 17/179,779

(22) Filed: Feb. 19, 2021

(51) Int. Cl. G06Q 10/02; G06Q 50/30; G06Q 30/02

(52) U.S. Cl. CPC G06Q 10/02; G06Q 50/30; G06Q 30/0282; G06Q 30/0206

(57) ABSTRACT

Systems and methods for an aviation-based entity rating platform are disclosed. For example, upon the occurrence of a triggering event, request data for rating information may be sent to various entities associated with a flight, including travelers, brokers, operators, and/or owners. Rating information may be received and may be utilized to generate rating data, determine rating questions, generate flight-related recommendations, and for dynamic display of ratings based on user preferences and flight data.

### BACKGROUND

Private aviation, such as the use of private jets to transport a small group of people, is available. Unlike travel via commercial airliners, entities associated with a given flight are dynamic, such as pilots, crew members, caterers, brokers, operators, and owners, as well as objects such as the aerial vehicle. Described herein are improvements in technology and solutions to technical problems that can be used to, among other things, assist in evaluating aviation-based entities.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for an aviation-based entity rating platform.

FIG. 2 illustrates a sequence diagram showing an example process associated with an aviation-based entity rating platform.

FIG. 3 illustrates an example user interface for use by one or more aerial vehicle travelers to provide user input associated with an aviation-based entity rating platform.

FIG. 4 illustrates an example user interface for use by one or more aerial vehicle travelers to view rating information associated with an aviation-based entity rating platform.

FIG. 5 illustrates an example user interface for use by one or more aerial vehicle operators and/or owners to view and interact with rating information associated with an aviation-based entity rating platform.

FIG. 6 illustrates an example user interface for use by one or more aerial vehicle operators and/or owners for viewing and interacting with one or more recommendations associated with an aviation-based entity rating platform.

FIG. 7 illustrates a flow diagram of an example process for utilizing an aviation-based entity rating platform.

FIG. 8 illustrates a flow diagram of another example process for utilizing an aviation-based entity rating platform.

### DETAILED DESCRIPTION

Systems and methods for an aviation-based entity rating platform are disclosed. Take, for example, a situation where one or more aerial vehicle travelers desire to book an aerial vehicle for use by those travelers, particularly when the aerial vehicle is considered a private aerial vehicle such as a private jet and/or helicopter for example. The aerial vehicle may be owned by an aerial vehicle owner who may engage with an aerial vehicle operator to perform actions associated with operating the aerial vehicle. To assist in booking the aerial vehicle for flights, the aerial vehicle operator may engage with one or more aerial vehicle flight brokers, who communicate with potential aerial vehicle travelers to sell flights on the aerial vehicle. A platform may be provided to assist with the booking and management of aerial vehicle flights across multiple travelers, brokers, operators, and owners. The platform may provide functionality to allow for these entities to engage with each other in a secure, time-sensitive manner without the need for prolonged communications and booking request confirmation, for example. Also, given that the platform has access to each traveler, broker, operator, owner, and/or other entities associated with aerial vehicle flights, the platform may allow for quality control and/or quality measurement functionality to improve performance not only of the platform, but also the usability of the platform by such entities.

To assist in these and other goals, the present disclosure includes an aviation-based entity rating platform configured to request and receive rating information from one or more of the entities that utilize the platform. For example, the aviation-based entity rating system may include a remote system that is remote from one or more devices associated with the travelers, brokers, operators, and/or owners. The remote system may be configured to schedule aerial vehicle flights and to generate and provide user interfaces to the entities associated with the aerial vehicle flights. For example, a given traveler may book an aerial vehicle for use on a given day and during a given time frame. The aerial vehicle may be owned by a given owner and operated by a given operator. The traveler may also have booked the flight via a given broker. Once the flight is scheduled, one or more rating triggering events may be utilized to determine when to request rating information from one or more of the entities. For example, the rating triggering events may include occurrence of a scheduled departure time, an indication that the flight has initiated, an indication that the flight has been completed, an indication that the flight has been booked, lapsing of the given time frame for scheduled use of the aerial vehicle, lapsing of a period of time after the flight has been completed, receipt of payment associated with the scheduled flight, and/or one or more other events where one or more of the entities may be willing to providing rating information. One or more machine learning models may be utilized to determine a likelihood that a request for rating information will be accepted in response to given rating triggering events and may be configured to determine which rating triggering events are most likely to be accepted. These machine learning models may be trained utilizing historical rating information and acceptance of past requests for rating information.

When a rating triggering event occurs, a request component of the remote system may be configured to generate and send request data for the rating information. The request data may identify the flight at issue and details associated with the flight, such as the aerial vehicle, broker, operator, traveler(s), owner, and/or any other attributes of the flight. The request data may also cause a user interface to be displayed on one or more devices associated with the entities. The user interface may display, for example, text requesting that the entity provide rating information. In instances where the entity provides user input indicating acceptance of the request to provide rating information, the user interface may display functionality for requesting and receiving user input for rating one or more of the attributes of the flight. For example, request data sent to a traveler device associated with a traveler of the flight may indicate the aerial vehicle, broker, operator, crew, and/or services associated with the flight. The user interface may be configured to receive user input data indicating the traveler's subjective rating of one or more of these entities and/or attributes. As will be described herein by way of example, and not as a limitation, the user interface may be configured to display five stars that are selectable to express the user's rating, with a five-star selection indicating a most favorable rating and a one-star selection indicating a least favorable rating. It should be understood that any rating system and/or way to present such a rating system is included in this disclosure. The use of stars, a given rating scale, or types of rating input mechanisms are not described herein as limitations of how the ratings may be provided by the entities. The request data may also cause display of one or more specific questions to which answers are solicited by the aviation-based entity rating system. The questions may be specific to the entities type (e.g., traveler, broker, etc.), the flight at issue, the specific entity at issue, etc.

Additionally, or alternatively, the request data may include an ability for the entity to provide open-ended comments or in other words provide user input that is not in response to a specific question. Text data representing these comments may be received by the remote system and may be analyzed to determine what specific questions may be asked for subsequent ratings. For example, one or more machine learning models may be generated and trained based at least in part on the text data from multiple comments received over time by the aviation-based entity rating platform. In these examples, the machine learning models may be configured to identify trends in comments, and a question generator of the remote system may be configured to develop questions to pose to entities based on those trends. For example, if comments frequently include mention of poor food quality, the machine learning model may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc.

The entities may utilize the user interfaces described herein to provide user input representing the requested rating information, including selection of a rating for given attributes of the flight, answers to specific questions, and/or input of comments as described herein. This rating information may be sent from the devices associated with the entities to the remote system. A rating component of the remote system may be configured to receive the rating information and to generate rating data based at least in part on the rating information. The rating data may associate a rating with the one or more attributes of the flights, such as over time. For example, rating information on the cleanliness of a given aerial vehicle may be receive by multiple travelers over multiple flights over time. The rating information may be utilized to generate an overall rating for the cleanliness of the aerial vehicle, which may impact a rating for the aerial vehicle itself. In these and other examples, the rating component may be configured to weight or otherwise implement one or more factors to generate a rating that considers the rating information that is received. For example, certain rating information received closest in time may be weighted more heavily (e.g., may impact the rating more) than rating information received years ago, particularly with respect to attributes that are likely to degrade over time, such as aerial vehicle cleanliness, newness, etc. Additional factors may be utilized to determine how to weight ratings, such as whether the rating information was received from a frequent traveler, whether the rating information was consistent or inconsistent with rating information received by other travelers on the same flight, etc. Additionally, the weighting of ratings as described herein may be performed dynamically and specifically for a given entity to which the ratings are to be displayed. For example, for a given traveler, that traveler may have provided user input associated with user preferences, which may indicate that the traveler places more importance on on-time departure than flight amenities. In these examples, the rating information may be weighted differently from another traveler with user preferences that indicate flight amenities are more important to that traveler than on-time departures. In this example, when the first traveler is presented with ratings on flights, for example, a rating for a flight and/or operator may be weighted such that ratings associated with departure timeliness are more heavily weighted than ratings associated with amenities. As such, the rating displayed for a given flight, attribute of a flight, and/or entities associated with a flight may change not only based on the rating information received by raters, but also based at least in part on the user profile associated with viewing the ratings.

The rating component may also be configured to aggregate ratings such that an overall rating is generated for a flight and/or aspects associated with a flight. For example, rating information may be received for aircraft cleanliness, expected amenities, and comfort. This rating information may be aggregated or otherwise stacked to provide an aggregate rating for the aircraft. This same aggregation process may be performed for one or more other aspects associated with a flight, such as ratings for the crew, ratings for the broker, ratings for the services provided, etc. It should be understood that while several examples provided herein are associated with rating the flight and attributes of the flight, ratings may also be provided for travelers. For example, user interfaces associated with the brokers, operators, crew, etc. may be caused to display requests for rating information associated with the travelers of a flight. Ratings may be generated for individual travelers and may be utilized by the remote system as described herein.

A flight data generator of the remote system may be configured to generate flight data associated with aerial vehicle flights, which may be utilized by the rating component to generate the rating data. For example, the flight data may include attributes associated with the flight itself, such as a departure time of the flight, an arrival time of the flight, a number of crew members for the flight, any issues experienced with the flight, an age of the aerial vehicle, and/or any other attributes of the flight itself. This information may be utilized to influence ratings associated with the flight and/or one or more entities associated with the flight. For example, even when user rating information does not indicate frequent late departure of a flight, if the flight data does provide such an indication, the rating of the timeliness of the flight may be negatively impacted by the flight data.

A price component of the remote system may be configured to generate price recommendations associated with flights, such as based at least in part on the rating data described herein. For example, the aviation-based entity rating platform may be configured such that various flights may be offered for use at various prices. The aviation-based entity rating platform may provide recommendations to brokers, operators, and/or owners for how much to offer given flights for. Those recommendations may be based at least in part on a number of factors, including ratings associated with the flight. Flights with higher ratings may command a higher price than flights with lower ratings, and/or flights with high ratings for attributes that are indicated as important to a given traveler may command a higher price than flights with high ratings for attributes that are not as important to a given traveler. The price component may be configured to analyze ratings associated with a given flight with respect to ratings of other flights, such as flights having similar attributes, to determine a recommended price to offer the given flight for. Recommendation data may be generated and sent to the broker, operator, and/or owner and user input data may be received that accepts or rejects the recommendation. When accepted, the price associated with the flight may be updated to the recommended price.

An auto-booking component of the remote system may be configured to provide auto-booking functionality for given flights. The rating data described herein may be utilized to influence the availability of auto-booking functionality. For example, one or more rules, which may be specific to a given aerial vehicle, broker, operator, and/or owner may be generated for when auto-booking functionality is to be made available. An example rule may be that auto-booking functionality is to be made available for all flights associated with a given operator when all potential travelers have a rating that satisfies a threshold rating, and/or when the broker involved in the transaction has a rating that satisfies a threshold rating. In this way, operators, brokers, and/or owners can take advantage of auto-booking functionality only when those entities are comfortable with booking a flight given the ratings of entities involved in the flight. The rules for auto-booking functionality enablement may be generated based at least in part on user input data from the brokers, operators, and/or owners and/or based at least in part on defaults established by the aviation-based entity rating platform. While examples are provided herein for the auto-booking rules, it should be understood that any rule may be generated and the rule may be based at least in part on any information, including any information associated with the ratings described herein.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

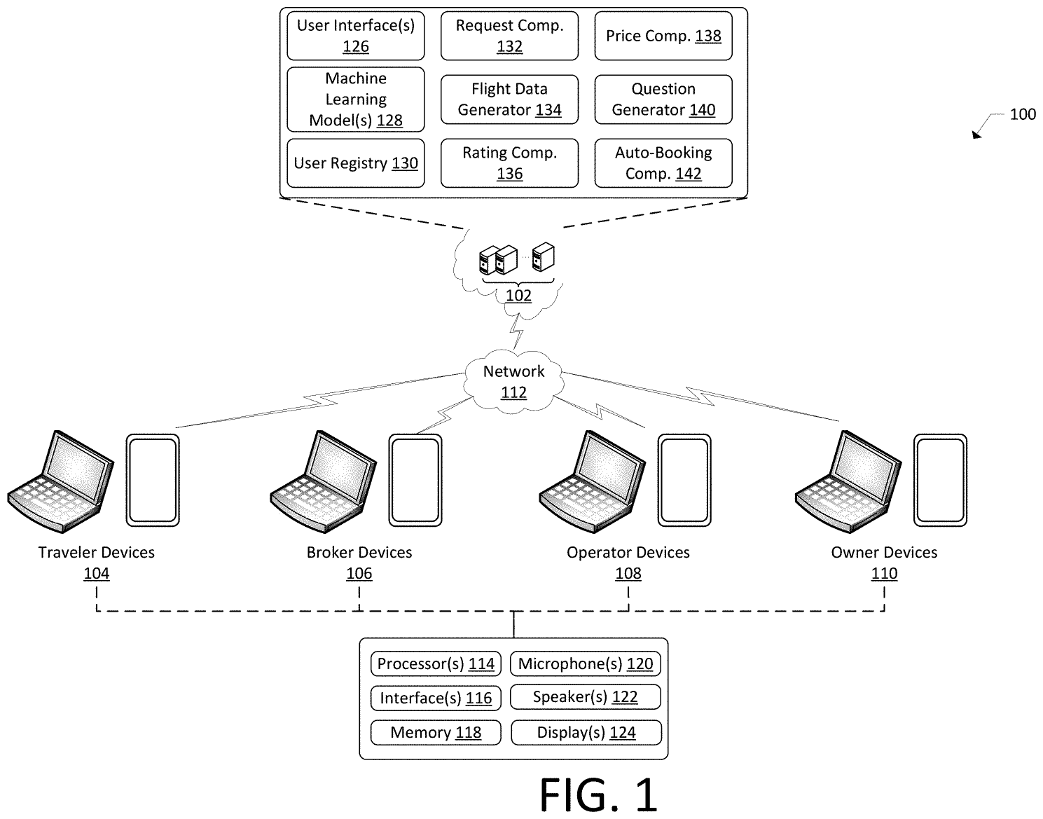

FIG. 1 illustrates a schematic diagram of an example system 100 for an aviation-based entity rating platform. The system 100 may include, for example, a remote system 102 associated with the aviation-based user platform, traveler devices 104, broker devices 106, operator devices 108, and/or owner devices 110. Each of these devices may include any computing devices configured to receive data from one or more of the other devices and/or the remote system 102 and/or to send data from one or more of the other devices and/or the remote system 102, such as via a network 112.

It should be understood that where operations are described herein as being performed by the remote system 102, some or all of those operations may be performed by the devices 104, 106, 108, 110. It should also be understood that anytime the remote system 102 is referenced, that system may include any system and/or device, whether local to an environment of the devices 104, 106, 108, 110 or remote from that environment. Additionally, it should be understood that a given space and/or environment may include numerous devices 104, 106, 108, 110. It should also be understood that when a “space” or “environment” is used herein, those terms mean an area and not necessarily a given room, building, or other structure, unless otherwise specifically described as such.

One or more of the traveler devices 104, broker devices 106, operator devices 108, and/or owner devices 110 may include one or more components such as one or more processors 114, one or more network interfaces 116, memory 118, one or more microphones 120, one or more speakers 122, and/or one or more displays 124. The microphones 120 may be configured to receive audio from an environment associated with one or more of the devices 104, 106, 108, 110 and generate corresponding audio data. The speakers 122 may be configured to receive audio data and output corresponding audio. The displays 124 may be configured to display information as will be described more fully herein.

The remote system 102 may include components such as, for example, one or more user interfaces 126, one or more machine learning models 128, a user registry 130, a request component 132, a flight data generator 134, a rating component 136, a price component 138, a question generator 140, and/or an auto-booking component 142. It should be understood that while the components of the remote system 102 are depicted and/or described as separate from each other in FIG. 1, some or all of the components may be a part of the same system. It should also be understood that the remote system 102 may include one or more processors, one or more network interfaces, and memory that stores the components described herein. Each of the components of the remote system 102 will be described in more detail below by way of example.

By way of example, the remote system 102 may be configured to schedule aerial vehicle flights and to generate and provide the user interfaces 126 to the entities associated with the aerial vehicle flights. For example, a given traveler may book an aerial vehicle for use on a given day and during a given time frame. The aerial vehicle may be owned by a given owner and operated by a given operator. The traveler may also have booked the flight via a given broker. Once the flight is scheduled, one or more rating triggering events may be utilized to determine when to request rating information from one or more of the entities. For example, the rating triggering events may include occurrence of a scheduled departure time, an indication that the flight has initiated, an indication that the flight has been completed, lapsing of the given time frame for scheduled use of the aerial vehicle, lapsing of a period of time after the flight has been completed, receipt of payment associated with the scheduled flight, and/or one or more other events where one or more of the entities may be willing to providing rating information. One or more of the machine learning models 128 may be utilized to determine a likelihood that a request for rating information will be accepted in response to given rating triggering events and may be configured to determine which rating triggering events are most likely to be accepted. These machine learning models 128 may be trained utilizing historical rating information and acceptance of past requests for rating information. Determination of the triggering events may be made by the machine learning models 128 and/or the rating component 136.

When a rating triggering event occurs, the request component 132 may be configured to generate and send request data for the rating information. The request data may identify the flight at issue and details associated with the flight, such as the aerial vehicle, broker, operator, traveler(s), owner, and/or any other attributes of the flight. The request data may also cause a user interface 126 to be displayed on one or more devices 104, 106, 108, 110 associated with the entities. The user interface 126 may display, for example, text requesting that the entity provide rating information. In instances where the entity provides user input indicating acceptance of the request to provide rating information, the user interface 126 may display functionality for requesting and receiving user input for rating one or more of the attributes of the flight. For example, request data sent to a traveler device 104 associated with a traveler of the flight may indicate the aerial vehicle, broker, operator, crew, and/or services associated with the flight. The user interface 126 may be configured to receive user input data indicating the traveler's subjective rating of one or more of these entities and/or attributes. As will be described herein by way of example, and not as a limitation, the user interface 126 may be configured to display five stars that are selectable to express the user's rating, with a five-star selection indicating a most favorable rating and a one-star selection indicating a least favorable rating. It should be understood that any rating system and/or way to present such a rating system is included in this disclosure. The use of stars, a given rating scale, or types of rating input mechanisms are not described herein as limitations of how the ratings may be provided by the entities. The request data may also cause display of one or more specific questions to which answers are solicited by the aviation-based entity rating system. The questions may be specific to the entities type (e.g., traveler, broker, etc.), the flight at issue, the specific entity at issue, etc.

Additionally, or alternatively, the request data may include an ability for the entity to provide open-ended comments or in other words provide user input that is not in response to a specific question. Text data representing these comments may be received by the remote system 102 and may be analyzed to determine what specific questions may be asked for subsequent ratings. For example, one or more machine learning models 128 may be generated and trained based at least in part on the text data from multiple comments received over time by the aviation-based entity rating platform. In these examples, the machine learning models 128 may be configured to identify trends in comments, and the question generator 140 may be configured to develop questions to pose to entities based on those trends. For example, if comments frequently include mention of poor food quality, the machine learning model 128 may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc. Analysis of the text data to determine attributes of the text data may include the use of natural language processing, which may result in the generation of intent data indicating a determined intent and/or subject associated with the comments.

The entities may utilize the user interfaces 126 described herein to provide user input representing the requested rating information, including selection of a rating for given attributes of the flight, answers to specific questions, and/or input of comments as described herein. This rating information may be sent from the devices 104, 106, 108, 110 associated with the entities to the remote system 102. The rating component 136 may be configured to receive the rating information and to generate rating data based at least in part on the rating information. The rating data may associate a rating with the one or more attributes of the flights, such as over time. For example, rating information on the cleanliness of a given aerial vehicle may be received by multiple travelers over multiple flights over time. The rating information may be utilized to generate an overall rating for the cleanliness of the aerial vehicle, which may impact a rating for the aerial vehicle itself. In these and other examples, the rating component may be configured to weight or otherwise implement one or more factors to generate a rating that considers the rating information that is received. For example, certain rating information received closest in time may be weighted more heavily (e.g., may impact the rating more) than rating information received years ago, particularly with respect to attributes that are likely to degrade over time, such as aerial vehicle cleanliness, newness, etc. Additional factors may be utilized to determine how to weight ratings, such as whether the rating information was received from a frequent traveler, whether the rating information was consistent or inconsistent with rating information received by other travelers on the same flight, etc. Additionally, the weighting of ratings as described herein may be performed dynamically and specifically for a given entity to which the ratings are to be displayed. For example, for a given traveler, that traveler may have provided user input associated with user preferences, which may indicate that the traveler places more importance on on-time departure than flight amenities. In these examples, the rating information may be weighted differently from another traveler with user preferences that indicate flight amenities are more important to that traveler than on-time departures. In this example, when the first traveler is presented with ratings on flights, for example, a rating for a flight and/or operator may be weighted such that ratings associated with departure timeliness are more heavily weighted than ratings associated with amenities. As such, the rating displayed for a given flight, attribute of a flight, and/or entities associated with a flight may change not only based on the rating information received by raters, but also based at least in part on the user profile associated with viewing the ratings.

The rating component 136 may also be configured to aggregate ratings such that an overall rating is generated for a flight and/or aspects associated with a flight. For example, rating information may be received for aircraft cleanliness, expected amenities, and comfort. This rating information may be aggregated to provide an aggregate rating for the aircraft. This same aggregation process may be performed for one or more other aspects associated with a flight, such as ratings for the crew, ratings for the broker, ratings for the services provided, etc. It should be understood that while several examples provided herein are associated with rating the flight and attributes of the flight, ratings may also be provided for travelers. For example, user interfaces 126 associated with the brokers, operators, crew, etc. may be caused to display requests for rating information associated with the travelers of a flight. Ratings may be generated for individual travelers and those ratings may be utilized by the remote system 102 as described herein.

The flight data generator 134 may be configured to generate flight data associated with aerial vehicle flights, which may be utilized by the rating component 136 to generate the rating data. For example, the flight data may include attributes associated with the flight itself, such as a departure time of the flight, an arrival time of the flight, a number of crew members for the flight, any issues experienced with the flight, an age of the aerial vehicle, and/or any other attributes of the flight itself. This information may be utilized to influence ratings associated with the flight and/or one or more entities associated with the flight. For example, even when user rating information does not indicate frequent late departure of a flight, if the flight data does provide such an indication, the rating of the timeliness of the flight may be negatively impacted by the flight data.

The price component 138 may be configured to generate price recommendations associated with flights, such as based at least in part on the rating data described herein. For example, the aviation-based entity rating platform may be configured such that various flights may be offered for use at various prices. The aviation-based entity rating platform may provide recommendations to brokers, operators, and/or owners for how much to offer given flights for. Those recommendations may be based at least in part on a number of factors, including ratings associated with the flight. Flights with higher ratings may command a higher price than flights with lower ratings, and/or flights with high ratings for attributes that are indicated as important to a given traveler may command a higher price than flights with high ratings for attributes that are not as important to a given traveler. The price component 138 may be configured to analyze ratings associated with a given flight with respect to ratings of other flights, such as flights having similar attributes, to determine a recommended price to offer the given flight for. Recommendation data may be generated and sent to the broker, operator, and/or owner and user input data may be received that accepts or rejects the recommendation. When accepted, the price associated with the flight may be updated to the recommended price. The price component 138 may utilize one or more of the machine learning models 128 described herein to perform the analysis on prior price data and the ratings data to generate a price recommendation. In these examples, the machine learning models may be trained utilizing a training dataset including the prior price information, which may be from disparate aerial vehicles, brokers, and/or operators, as well as the rating information.

The auto-booking component 142 may be configured to provide auto-booking functionality for given flights. The rating data described herein may be utilized to influence the availability of auto-booking functionality. For example, one or more rules, which may be specific to a given aerial vehicle, broker, operator, and/or owner may be generated for when auto-booking functionality is to be made available. An example rule may be that auto-booking functionality is to be made available for all flights associated with a given operator when all potential travelers have a rating that satisfies a threshold rating, and/or when the broker involved in the transaction has a rating that satisfies a threshold rating. In this way, operators, brokers, and/or owners can take advantage of auto-booking functionality only when those entities are comfortable with booking a flight given the ratings of entities involved in the flight. The rules for auto-booking functionality enablement may be generated based at least in part on user input data from the brokers, operators, and/or owners and/or based at least in part on defaults established by the aviation-based entity rating platform. While examples are provided herein for the auto-booking rules, it should be understood that any rule may be generated and the rule may be based at least in part on any information, including any information associated with the ratings described herein.

The user registry 130 as described herein may store data associated with one or more user profiles and/or user accounts associated with users of the aviation-based user platform. One or more of the entities that interact with the aviation-based user platform may be associated with a user profile and/or user account. The user profiles and/or user accounts may store data associated with the entities, including for example user preference data, device identifier data, historical use data, geographic location data, flight scheduling data, prior flight data, and/or any other data associated with the entities use of the aviation-based user platform.

It should be noted that while text data is described as a type of data utilized to communicate between various components of the remote system 102 and/or other systems and/or devices, the components of the remote system 102 may use any suitable format of data to communicate. For example, the data may be in a human-readable format, such as text data formatted as XML, SSML, and/or other markup language, or in a computer-readable format, such as binary, hexadecimal, etc., which may be converted to text data for display by one or more devices such as the devices 104, 106, 108, 110.

As shown in FIG. 1, several of the components of the remote system 102 and the associated functionality of those components as described herein may be performed by one or more of the devices 104, 106, 108, 110. Additionally, or alternatively, some or all of the components and/or functionalities associated with the devices 104, 106, 108, 110 may be performed by the remote system 102.

It should be noted that the exchange of data and/or information as described herein may be performed only in situations where a user has provided consent for the exchange of such information. For example, upon setup of devices and/or initiation of applications, a user may be provided with the opportunity to opt in and/or opt out of data exchanges between devices and/or for performance of the functionalities described herein. Additionally, when one of the devices is associated with a first user account and another of the devices is associated with a second user account, user consent may be obtained before performing some, any, or all of the operations and/or processes described herein. Additionally, the operations performed by the components of the systems described herein may be performed only in situations where a user has provided consent for performance of the operations.

As used herein, a processor, such as processor(s) 114 and/or the processor(s) described with respect to the components of the remote system 102, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 114 and/or the processor(s) described with respect to the components of the remote system 102 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 114 and/or the processor(s) described with respect to the components of the remote system 102 may possess its own local memory, which also may store program components, program data, and/or one or more operating systems.

The memory 118 and/or the memory described with respect to the components of the remote system 102 may include volatile and nonvolatile memory, removable and non-removable media implemented in any method or technology for storage of information, such as computer-readable instructions, data structures, program component, or other data. Such memory 118 and/or the memory described with respect to the components of the remote system 102 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 118 and/or the memory described with respect to the components of the remote system 102 may be implemented as computer-readable storage media (“CRSM”), which may be any available physical media accessible by the processor(s) 114 and/or the processor(s) described with respect to the remote system 102 to execute instructions stored on the memory 118 and/or the memory described with respect to the components of the remote system 102. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 118 and/or the memory described with respect to the components of the remote system 102, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 116 and/or the network interface(s) described with respect to the components of the remote system 102 may enable messages between the components and/or devices shown in system 100 and/or with one or more other polling systems, as well as other networked devices. Such network interface(s) 116 and/or the network interface(s) described with respect to the components of the remote system 102 may include one or more network interface controllers (NICs) or other types of transceiver devices to send and receive messages over the network 112.

For instance, each of the network interface(s) 116 and/or the network interface(s) described with respect to the components of the remote system 102 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 116 and/or the network interface(s) described with respect to the components of the remote system 102 may include a wide area network (WAN) component to enable message over a wide area network.

In some instances, the remote system 102 may be local to an environment associated the devices 104, 106, 108, 110. For instance, the remote system 102 may be located within one or more of the devices 104, 106, 108, 110. In some instances, some or all of the functionality of the remote system 102 may be performed by one or more of the devices 104, 106, 108, 110. Also, while various components of the remote system 102 have been labeled and named in this disclosure and each component has been described as being configured to cause the processor(s) to perform certain operations, it should be understood that the described operations may be performed by some or all of the components and/or other components not specifically illustrated. It should be understood that, in addition to the above, some or all of the operations described herein may be performed on a phone or other mobile device and/or on a device local to the environment, such as, for example, a hub device.

The machine learning models 128 as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases and may be utilized to predict trends and behavior patterns. In examples, the event, otherwise described herein as an outcome, may be an event that will occur in the future, such as whether presence will be detected. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Then, data may be collected and/or accessed to be used for analysis.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter, predictive modelling may be performed to generate accurate predictive models for future events. Outcome prediction may be deterministic such that the outcome is determined to occur or not occur. Additionally, or alternatively, the outcome prediction may be probabilistic such that the outcome is determined to occur to a certain probability and/or confidence.

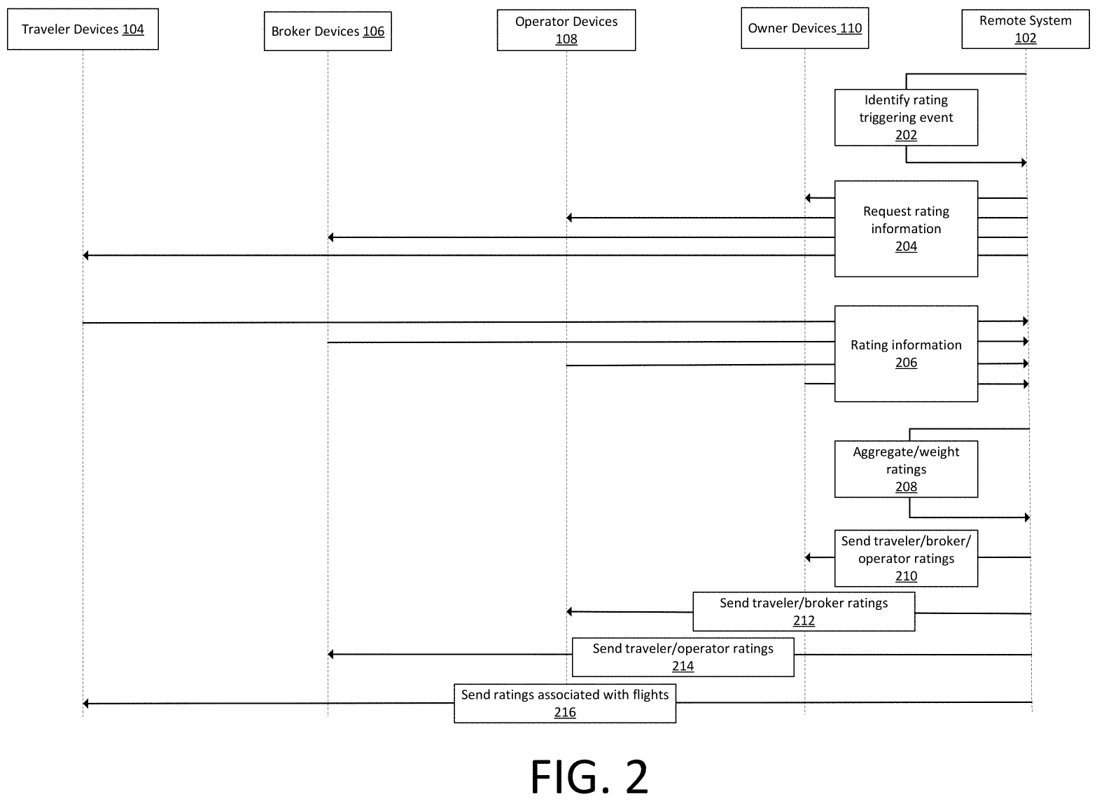

FIG. 2 illustrates a sequence diagram showing an example process associated with an aviation-based entity rating platform. While the sequence diagram depicts the performance of operations and/or the transmission of certain data in a sequential manner, the operations may be performed in a different order than the order depicted in FIG. 2 and/or at least a portion of the operations may be performed in parallel.

At block 202, a remote system 102 may identify one or more rating triggering events. For example, once a flight is scheduled, one or more rating triggering events may be utilized to determine when to request rating information from one or more of the entities. For example, the rating triggering events may include occurrence of a scheduled departure time, an indication that the flight has initiated, an indication that the flight has been completed, lapsing of the given time frame for scheduled use of the aerial vehicle, lapsing of a period of time after the flight has been completed, receipt of payment associated with the scheduled flight, and/or one or more other events where one or more of the entities may be willing to providing rating information. One or more machine learning models may be utilized to determine a likelihood that a request for rating information will be accepted in response to given rating triggering events and may be configured to determine which rating triggering events are most likely to be accepted. These machine learning models may be trained utilizing historical rating information and acceptance of past requests for rating information.

At block 204, the remote system 102 may send request data for rating information to one or more of an owner device 110, an operator device 108, a broker device 106, and/or a traveler device 104. For example, when a rating triggering event occurs, a request component of the remote system may be configured to generate and send request data for the rating information. The request data may identify the flight at issue and details associated with the flight, such as the aerial vehicle, broker, operator, traveler(s), owner, and/or any other attributes of the flight. The request data may also cause a user interface to be displayed on one or more devices associated with the entities. The user interface may display, for example, text requesting that the entity provide rating information. In instances where the entity provides user input indicating acceptance of the request to provide rating information, the user interface may display functionality for requesting and receiving user input for rating one or more of the attributes of the flight. For example, request data sent to a traveler device associated with a traveler of the flight may indicate the aerial vehicle, broker, operator, crew, and/or services associated with the flight. The user interface may be configured to receive user input data indicating the traveler's subjective rating of one or more of these entities and/or attributes. As will be described herein by way of example, and not as a limitation, the user interface may be configured to display five stars that are selectable to express the user's rating, with a five-star selection indicating a most favorable rating and a one-star selection indicating a least favorable rating. It should be understood that any rating system and/or way to present such a rating system is included in this disclosure. The use of stars, a given rating scale, or types of rating input mechanisms are not described herein as limitations of how the ratings may be provided by the entities. The request data may also cause display of one or more specific questions to which answers are solicited by the aviation-based entity rating system. The questions may be specific to the entities type (e.g., traveler, broker, etc.), the flight at issue, the specific entity at issue, etc.

Additionally, or alternatively, the request data may include an ability for the entity to provide open-ended comments or in other words provide user input that is not in response to a specific question. Text data representing these comments may be received by the remote system and may be analyzed to determine what specific questions may be asked for subsequent ratings. For example, one or more machine learning models may be generated and trained based at least in part on the text data from multiple comments received over time by the aviation-based entity rating platform. In these examples, the machine learning models may be configured to identify trends in comments, and a question generator of the remote system may be configured to develop questions to pose to entities based on those trends. For example, if comments frequently include mention of poor food quality, the machine learning model may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc.

At block 206, one or more of the traveler device 104, the broker device 106, the operator device 108, and/or the owner device 110 may send the requested rating information to the remote system 102. For example, the entities may utilize the user interfaces described herein to provide user input representing the requested rating information, including selection of a rating for given attributes of the flight, answers to specific questions, and/or input of comments as described herein. This rating information may be sent from the devices associated with the entities to the remote system 102.

At block 208, the remote system 102 may aggregate and/or weight the rating information to generate rating data. For example, a rating component of the remote system 102 may be configured to receive the rating information and to generate rating data based at least in part on the rating information. The rating data may associate a rating with the one or more attributes of the flights, such as over time. For example, rating information on the cleanliness of a given aerial vehicle may be receive by multiple travelers over multiple flights over time. The rating information may be utilized to generate an overall rating for the cleanliness of the aerial vehicle, which may impact a rating for the aerial vehicle itself. In these and other examples, the rating component may be configured to weight or otherwise implement one or more factors to generate a rating that considers the rating information that is received. For example, certain rating information received closest in time may be weighted more heavily (e.g., may impact the rating more) than rating information received years ago, particularly with respect to attributes that are likely to degrade over time, such as aerial vehicle cleanliness, newness, etc. Additional factors may be utilized to determine how to weight ratings, such as whether the rating information was received from a frequent traveler, whether the rating information was consistent or inconsistent with rating information received by other travelers on the same flight, etc. Additionally, the weighting of ratings as described herein may be performed dynamically and specifically for a given entity to which the ratings are to be displayed. For example, for a given traveler, that traveler may have provided user input associated with user preferences, which may indicate that the traveler places more importance on on-time departure than flight amenities. In these examples, the rating information may be weighted differently from another traveler with user preferences that indicate flight amenities are more important to that traveler than on-time departures. In this example, when the first traveler is presented with ratings on flights, for example, a rating for a flight and/or operator may be weighted such that ratings associated with departure timeliness are more heavily weighted than ratings associated with amenities. As such, the rating displayed for a given flight, attribute of a flight, and/or entities associated with a flight may change not only based on the rating information received by raters, but also based at least in part on the user profile associated with viewing the ratings.

The rating component may also be configured to aggregate ratings such that an overall rating is generated for a flight and/or aspects associated with a flight. For example, rating information may be received for aircraft cleanliness, expected amenities, and comfort. This rating information may be aggregated to provide an aggregate rating for the aircraft. This same aggregation process may be performed for one or more other aspects associated with a flight, such as ratings for the crew, ratings for the broker, ratings for the services provided, etc. It should be understood that while several examples provided herein are associated with rating the flight and attributes of the flight, ratings may also be provided for travelers. For example, user interfaces associated with the brokers, operators, crew, etc. may be caused to display requests for rating information associated with the travelers of a flight. Ratings may be generated for individual travelers and may be utilized by the remote system as described herein.

A flight data generator of the remote system 102 may be configured to generate flight data associated with aerial vehicle flights, which may be utilized by the rating component to generate the rating data. For example, the flight data may include attributes associated with the flight itself, such as a departure time of the flight, an arrival time of the flight, a number of crew members for the flight, any issues experienced with the flight, an age of the aerial vehicle, and/or any other attributes of the flight itself. This information may be utilized to influence ratings associated with the flight and/or one or more entities associated with the flight. For example, even when user rating information does not indicate frequent late departure of a flight, if the flight data does provide such an indication, the rating of the timeliness of the flight may be negatively impacted by the flight data.

At block 210, the remote system 102 may send at least a portion of the rating data to the owner device 110. For example, the portion of the rating data may include ratings associated with travelers, the broker, and/or the operator. In this way, the owner may be able to view ratings associated with entities and/or attributes for the aerial vehicle that the owner owns.

At block 212, the remote system 102 may send at least a portion of the rating data to the operator device 108. For example, the portion of the rating data may include traveler ratings and/or broker ratings. In this way, the operator may be able to view ratings associated with entities and/or attributes for the aerial vehicle that the operator operates.

At block 214, the remote system 102 may send at least a portion of the rating data to the broker device 106. For example, the portion of the rating data may include traveler ratings and/or operator ratings. In this way, the broker may be able to view ratings associated with entities and/or attributes for the aerial vehicle that the broker is involved with.

At block 216, the remote system 102 may send at least a portion of the rating data to the traveler device 104. For example, the portion of the rating data may include ratings associates with flights for which the traveler is interested and/or may be interested. In this way, the traveler(s) may be able to view ratings associated with entities and/or attributes for the aerial vehicle that the traveler may schedule for use.

It should be understood that the portions of rating data that are described as being provided to the various entities with respect to this figure are described by way of example. Any of the rating data may be provided to any of the entities.

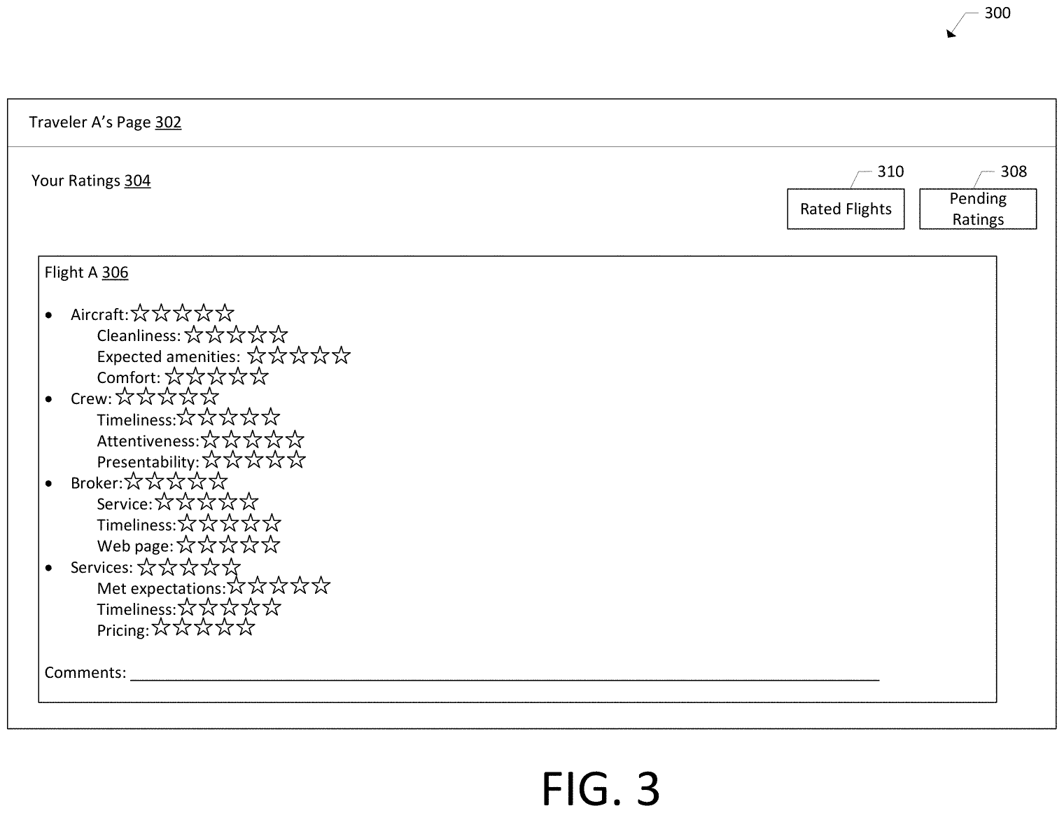

FIG. 3 illustrates an example user interface 300 for use by one or more aerial vehicle travelers to provide user input associated with an aviation-based entity rating platform. The user interface 300 may be the same or similar to the user interface 126 discussed elsewhere herein.

The user interface 300 may include a traveler page 302 associated with a user profile of a given traveler. For example, when a traveler registers to utilize the aviation-based user platform described herein, the traveler may provide user input for generation of a user profile to associate with the traveler. At least a portion of the user profile may be associated with ratings information, as described herein. For example, a ratings page 304 may be presented to the traveler via the user interface 300, and the ratings page 304 may present information associated with ratings that are associated with the traveler.

When a request for rating information has been provided to the traveler, such as with respect to a given flight that the traveler recently took, information associated with that request may be provided via the user interface 300. The request may provide a flight identifier 306 associated with the flight to be rated, along with individual attributes and/or entities associated with the flight to be rated. As shown in FIG. 3, the entities and/or attributes include the aircraft associated with the flight, the crew, the broker, and/or the services. For each of these categories, one or more subcategories of rating requests are also provided. For example, with respect to the aircraft, rating information is requested for the cleanliness, expected amenities, and comfort of the aircraft. For the crew category, rating information is requested for timeliness, attentiveness, and presentability. For the broker category, rating information is requested for service, timeliness, and the broker's web page. For the services category, rating information is requested for expectations, timeliness, and pricing.

Additionally, or alternatively, the request data may include an ability for the entity to provide open-ended comments or in other words provide user input that is not in response to a specific question. Text data representing these comments may be received by the remote system and may be analyzed to determine what specific questions may be asked for subsequent ratings. For example, one or more machine learning models may be generated and trained based at least in part on the text data from multiple comments received over time by the aviation-based entity rating platform. In these examples, the machine learning models may be configured to identify trends in comments, and a question generator of the remote system may be configured to develop questions to pose to entities based on those trends. For example, if comments frequently include mention of poor food quality, the machine learning model may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc.

The traveler may provide user input on the ratings of one or more of the requested attributes and/or entities, and that user input may be displayed to the user as confirmation of the received user input. The rating information provided by the user may be sent to the remote system and utilized for generating rating data as described herein.

The user interface 300 may also include one or more selectable elements, such as a pending requests element 308 and/or a rated flights element 310. The pending requests element 308 may be selectable, and when selected may cause a list of rating requests to be presented via the user interface 300. The traveler may select a request to provide rating information for and the request data associated with that request may be caused to be displayed on the user interface 300. The rated flights element 310 may be selectable, and when selected may cause a list of previous flights to which the traveler has provided rating information to be presented as well as, in examples, an indication of the ratings that the traveler provided.

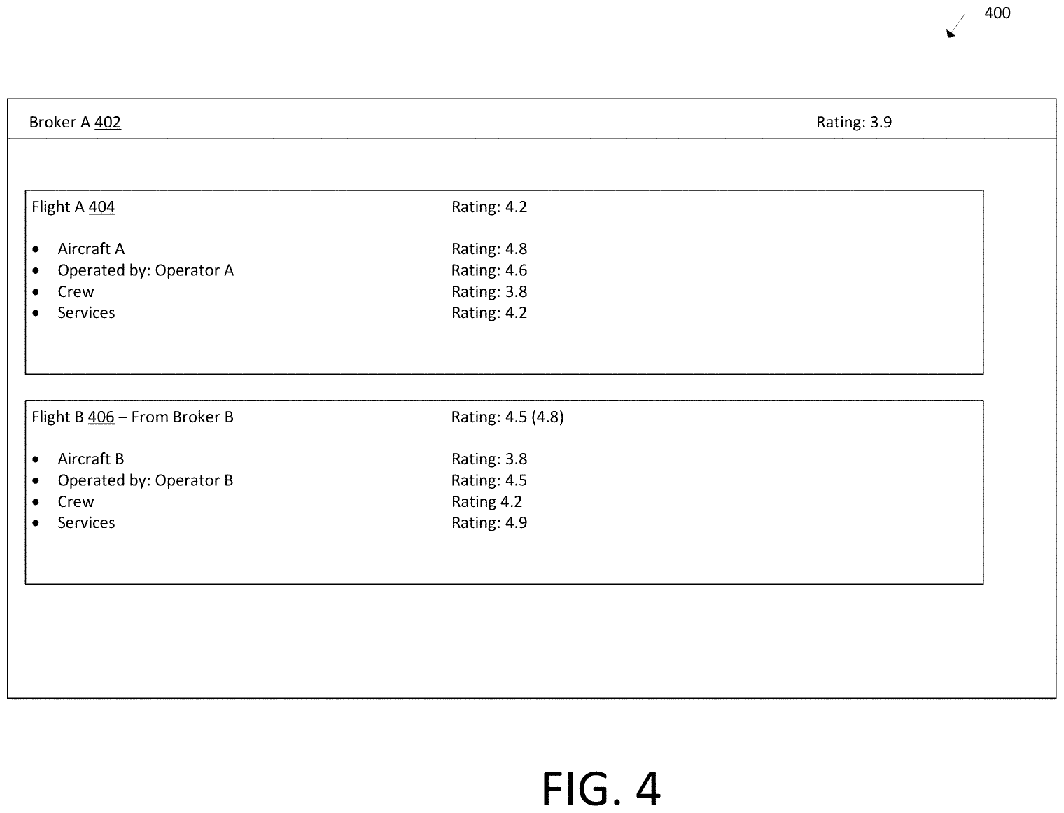

FIG. 4 illustrates an example user interface 400 for use by one or more aerial vehicle travelers to view rating information associated with an aviation-based entity rating platform. The user interface 400 may be the same or similar to the user interface 126 discussed elsewhere herein.

The user interface 400 may include a broker web page 402. For example, the aviation-based user platform may allow for flight brokers to utilize the aviation-based user platform to generate a web page 402 or other web-based location specific to a given broker where travelers can navigate to for scheduling flights and/or for obtaining private flight information. The aviation-based user platform may query the brokers for information associated with the brokers, such as operators that they are affiliated with, web page preferences, contact information, messaging preferences, auto-booking functionality enablement, etc. The aviation-based user platform may utilize some or all of this information to generate web pages for the flight brokers. Each of the web pages 402 may be at least partially unique to the given flight broker and the web pages 402 may be accessible to the flight broker and travelers. The flight broker web pages 402 may display information associated with available flights offered by the flight broker as well as functionality for travelers to contact the flight brokers, such as by secure messaging.

The user interface 400 may be caused to be displayed in response to traveler search queries for possible flights to book and/or for displaying potential flights to a traveler without being in response to a search query. Flight identifiers 404 and 406 may be displayed that identify the given flights that are being displayed. The user interface 400 may also display one or more ratings associated with the flights and/or attributes of the flights. For example, for Flight A 404, and overall rating of the flight (herein 4.2), as well as ratings for attributes of the flight such as the aircraft, the crew, the operator, and/or services associated with the flight may be provided. Additionally, when a given flight is not associated with the broker web page 402 being displayed, a rating associated with the broker to which the flight is associated may also be displayed. This is illustrated with respect to Flight B 406 and Broker B in FIG. 4. In this example, the rating for Flight B 406 is illustrated as 4.5 while the rating for Broker B is illustrated as 4.8, demarcated in brackets in FIG. 4. Additionally, the user interface 400 may provide a rating for the broker for which the web page 402 is associated. This is shown in FIG. 4 as a rating of 3.9 in the top-righthand corner of FIG. 4. The ratings displayed in FIG. 4 may have been generated by a rating component of the aviation-based entity rating platform as described more fully elsewhere herein.

The flights displayed with respect to the user interface 400 may also be prioritized based at least in part on the rating information. For example, user preference data may be received that indicates importance of one or more characteristics associated with use of the aerial vehicle by a traveler requesting use of the aerial vehicle. Flights may be determined with ratings associated with the one or more characteristics that satisfy a threshold rating. The user interface 400 may be caused to display the flights in a prioritized manner over other flights. For example, even though the overall rating for Flight A (4.2) is lower than the overall rating for Flight B (4.5), user preference data associated with the traveler at issue may indicate that aircraft ratings are more important to the traveler than other ratings. In this example, Aircraft A associated with Flight A has a rating of 4.8, while Aircraft B associated with Flight B has a rating of 3.8. As such, Flight A is prioritized over Flight B for at least this reason.

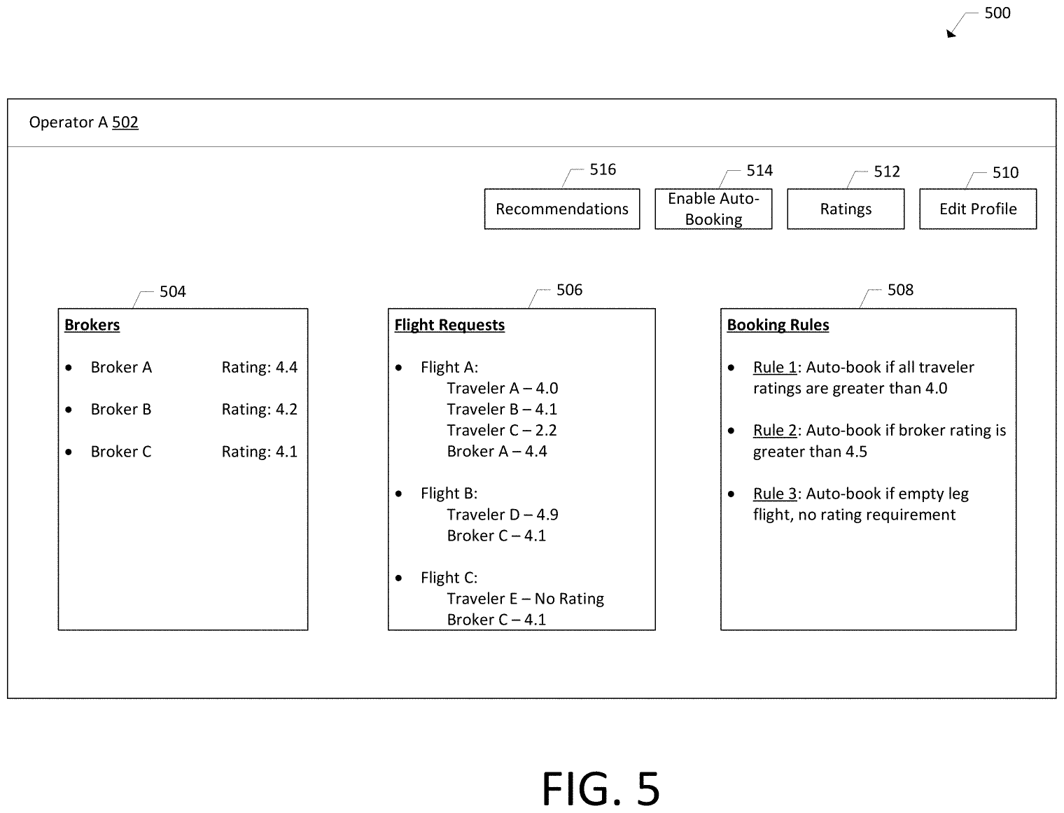

FIG. 5 illustrates an example user interface 500 for use by one or more aerial vehicle operators and/or owners to view and interact with rating information associated with an aviation-based entity rating platform. The user interface 500 may be the same or similar to the user interface 126 discussed elsewhere herein.

The user interface 500 may include an operator identifier 502 indicating the operator that is utilizing the user interface 500 of the aviation-based entity rating platform. The user interface 500 may also include a “brokers” portion 504, which may include a list of the brokers associated with the operator in question. The brokers portion 504 may also indicate ratings of the brokers and the list of broker may be caused to be displayed in a given order, such as an order based at least in part on the ratings of the brokers. As shown in FIG. 5, Broker A is illustrated as having a rating of 4.4, Broker B has a rating of 4.2, and Broker C has a rating of 4.1. The broker identifier may be selectable, and when selected the user interface 500 may display at least a portion of the rating information on which the rating for that broker is based. This may allow the operator to investigate reasons why the broker's rating is what it is.

The user interface 500 may also include a “flight requests” portion 506, which may include a list of flight requests that are pending acceptance or rejection by the operator. The flight requests portion 506 may identify the flights with pending confirmation requests along with information associated with those flights. For example, the information may include the ratings associated with entities for the flight and/or attributes of the flight. As shown in FIG. 5, for Flight A, ratings for Traveler A, Traveler B, Traveler C, and Broker A may be provided. This may allow operator to determine whether the entities involved in the potential flight have high enough ratings to accept the request or not. For example, for the request to schedule Flight A, Traveler C's rating is 2.2. This comparatively low rating may give the operator pause for confirming the flight.

The user interface 500 may also include a “booking rules” portion 506, which may include a list of rules generated for booking flights associated with the given operator. The booking rules may be based at least in part on the rating data described herein, as well as user input from the operator. As shown in FIG. 5, an example booking rule may be “auto-book if traveler ratings are greater than 4.0.” In this example, if flight information for a potential flight indicates that all travelers for the flight have a rating of greater than 4.0, then auto-booking functionality may be enabled for that flight and the operator may not need to provide confirmation before the flight can be booked. The rules may be based on other information other than traveler ratings. For example, Rule 2 may be “auto-book if broker rating is greater than 4.5,” or the rule may not be based on rating information but instead may be based on other information such as “auto-book if empty leg flight, no rating information.” It should be understood that any factors associated with flights and/or ratings may be utilized for generating and implementing booking rules.

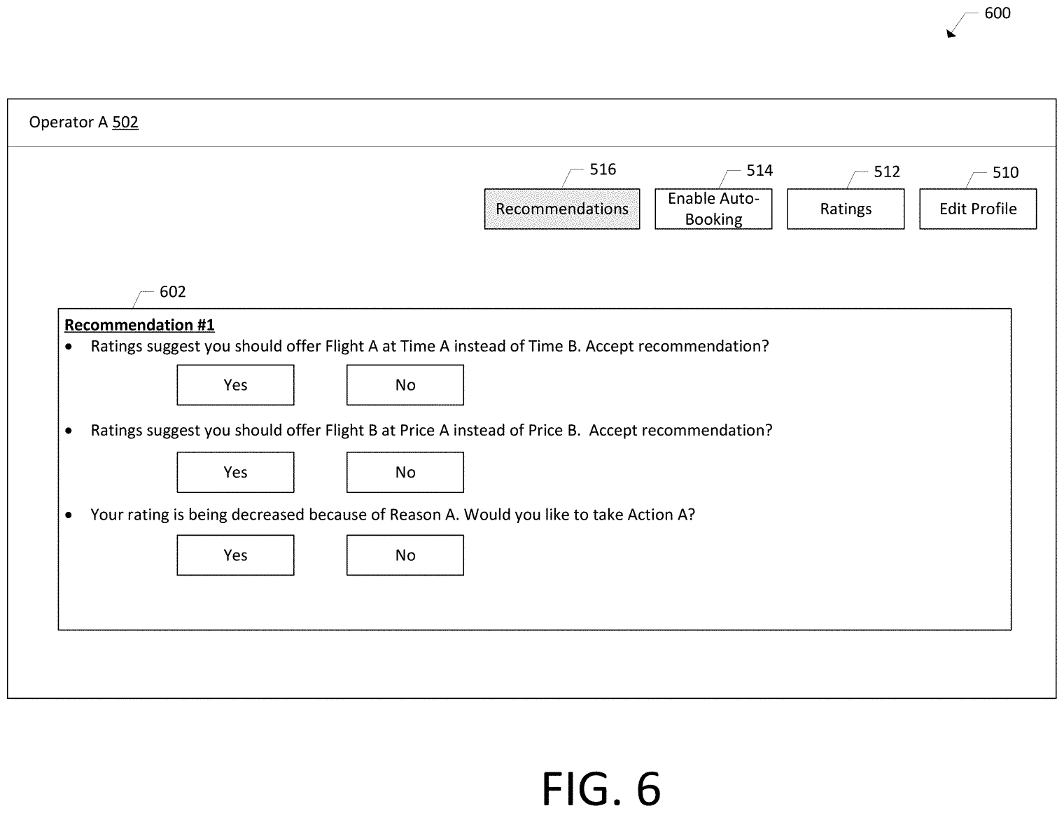

The user interface 500 may also include one or more selectable elements, such as an edit profile element 510, a ratings element 512, an enable auto-booking element 514, and/or a recommendations element 516. The edit profile element 510 may, when selected, allow the operator to view information associated with the operator's profile and to update that information as desired. The ratings element 512 may, when selected, allow the operator to see the operators rating as well as rating information associated with the rating. The enable auto-booking element 514 may, when selected, allow the operator to provide user input for enabling auto-booking functionality and/or to add, remove, and/or change booking rules associated with auto-booking functionality. The recommendations element 516 may, when selected, cause recommendations associated with the operator to be displayed, as will be described in more detail with respect to FIG. 6.

It should be understood that while the user interface 500 and functionality related thereto is described in FIG. 5 by way of example with respect to an operator, the user interface 500 may also be utilized by an aerial vehicle owner.

FIG. 6 illustrates an example user interface 600 for use by one or more aerial vehicle operators and/or owners for viewing and interacting with one or more recommendations associated with an aviation-based entity rating platform. The user interface 600 may be the same or similar to the user interface 126 discussed elsewhere herein.

The user interface 600 may be caused to be displayed when the recommendation element 514, such as described with respect to FIG. 5, is selected. When selected, a recommendation window 602 may be displayed on the user interface 600. The recommendation window 602 may provide a list of the pending recommendations associated with the operator and/or owner. The recommendations may have been generated as described herein, such as by utilizing one or more machine learning models.

The recommendations may include flight-based recommendations. A flight-based recommendation may indicate that a flight should be offered for departure at a different time than it is currently offered. The flight-based recommendation may be based on flight data indicating frequently departure delays, historical data indicating that when booked flights typically depart, and/or rating data indicating that timeliness of flight departure is problematic. The recommendations may also include price recommendations. A price component of the remote system may be configured to generate price recommendations associated with flights, such as based at least in part on the rating data described herein. For example, the aviation-based entity rating platform may be configured such that various flights may be offered for use at various prices. The aviation-based entity rating platform may provide recommendations to brokers, operators, and/or owners for how much to offer given flights for. Those recommendations may be based at least in part on a number of factors, including ratings associated with the flight. Flights with higher ratings may command a higher price than flights with lower ratings, and/or flights with high ratings for attributes that are indicated as important to a given traveler may command a higher price than flights with high ratings for attributes that are not as important to a given traveler. The price component may be configured to analyze ratings associated with a given flight with respect to ratings of other flights, such as flights having similar attributes, to determine a recommended price to offer the given flight for. Recommendation data may be generated and sent to the broker, operator, and/or owner and user input data may be received that accepts or rejects the recommendation. When accepted, the price associated with the flight may be updated to the recommended price. The recommendations may also include improvement recommendations for the operator to change something to improve his/her ratings. For example, the recommendation may state a determined reason why the operator's ratings are being decreased, and may present an action to take to mitigate the reason. For example, the reason may be traveler ratings associated with a given broker, and the action may be to stop working with that broker. Or the reason, for example, may be flight availability, and the action may be to increase availability in a certain way. The user interface 600 may provide functionality to allow the operator to provide user input for accepting or rejecting the recommendations, and when accepted the aviation-based entity rating system may take a corresponding action.

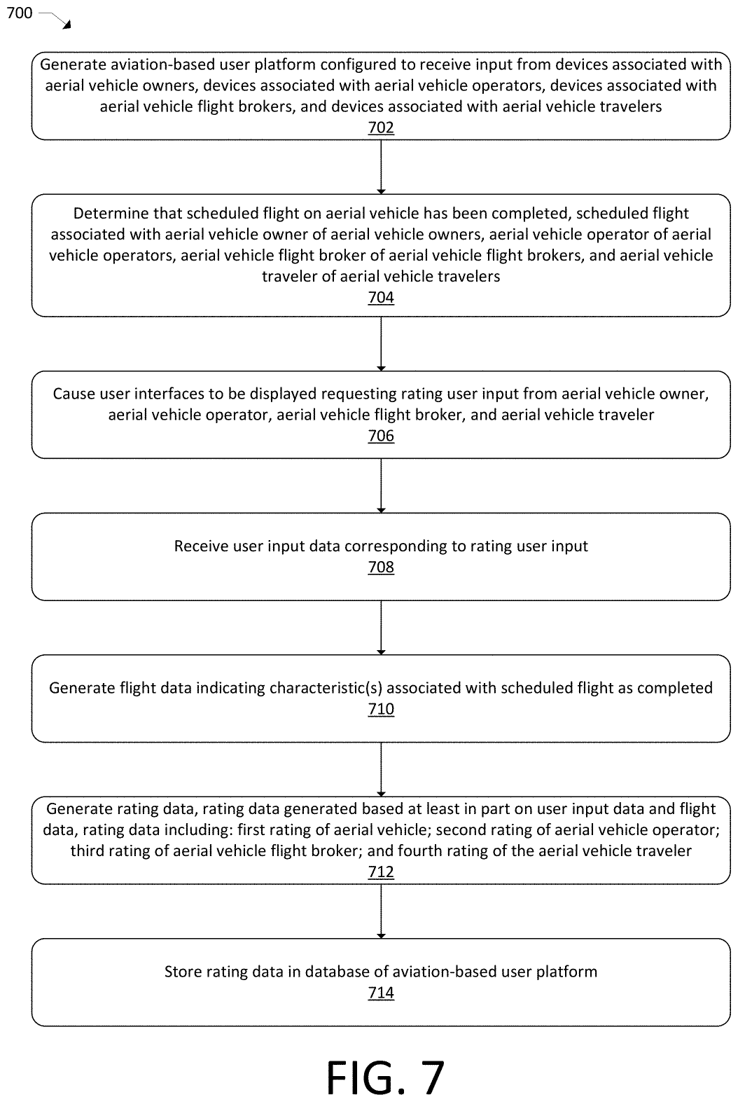

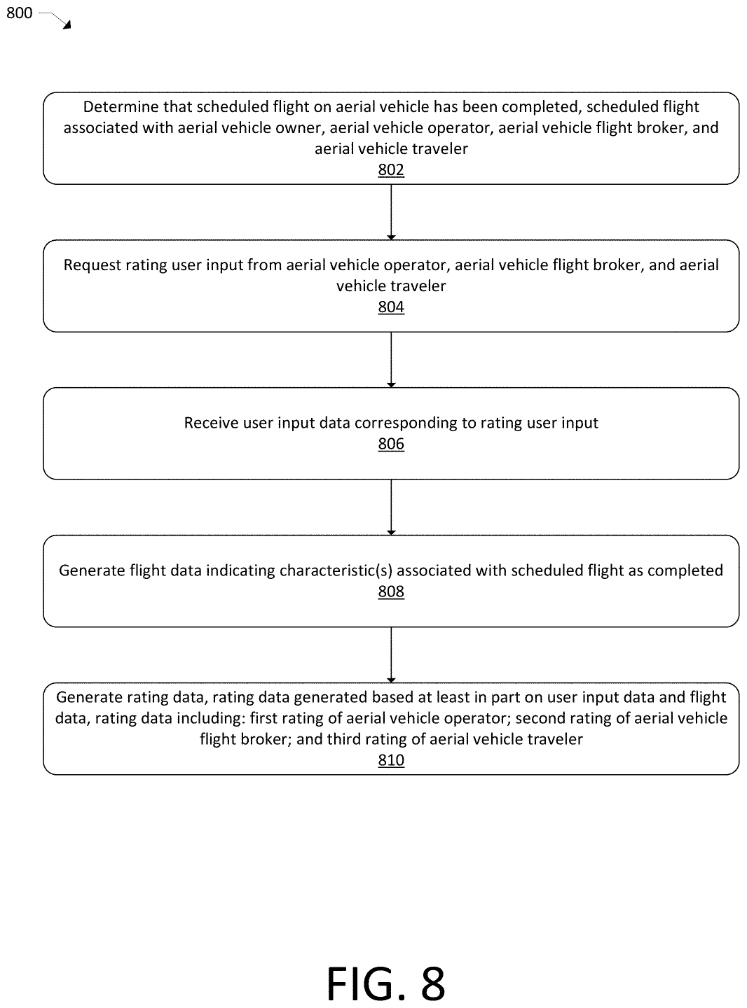

FIGS. 7 and 8 illustrate processes for aviation-based entity rating platforms. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-6, although the processes may be implemented in a wide variety of other environments, architectures and systems.

FIG. 7 illustrates a flow diagram of an example process 700 for utilizing an aviation-based entity rating platform. The order in which the operations or steps are described is not intended to be construed as a limitation, and any number of the described operations may be combined in any order and/or in parallel to implement process 700.

At block 702, the process 700 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 704, the process 700 may include determining that a scheduled flight on an aerial vehicle has been completed, the scheduled flight associated with an aerial vehicle owner of the aerial vehicle owners, an aerial vehicle operator of the aerial vehicle operators, an aerial vehicle flight broker of the aerial vehicle flight brokers, and an aerial vehicle traveler of the aerial vehicle travelers. For example, rating triggering events may include occurrence of a scheduled departure time, an indication that the flight has initiated, an indication that the flight has been completed, lapsing of the given time frame for scheduled use of the aerial vehicle, lapsing of a period of time after the flight has been completed, receipt of payment associated with the scheduled flight, and/or one or more other events where one or more of the entities may be willing to providing rating information. One or more machine learning models may be utilized to determine a likelihood that a request for rating information will be accepted in response to given rating triggering events and may be configured to determine which rating triggering events are most likely to be accepted. These machine learning models may be trained utilizing historical rating information and acceptance of past requests for rating information.

At block 706, the process 700 may include causing user interfaces to be displayed requesting rating user input from the aerial vehicle owner, the aerial vehicle operator, the aerial vehicle flight broker, and the aerial vehicle traveler. For example, when a rating triggering event occurs, a request component of the remote system may be configured to generate and send request data for the rating information. The request data may identify the flight at issue and details associated with the flight, such as the aerial vehicle, broker, operator, traveler(s), owner, and/or any other attributes of the flight. The request data may also cause a user interface to be displayed on one or more devices associated with the entities. The user interface may display, for example, text requesting that the entity provide rating information. In instances where the entity provides user input indicating acceptance of the request to provide rating information, the user interface may display functionality for requesting and receiving user input for rating one or more of the attributes of the flight. For example, request data sent to a traveler device associated with a traveler of the flight may indicate the aerial vehicle, broker, operator, crew, and/or services associated with the flight. The user interface may be configured to receive user input data indicating the traveler's subjective rating of one or more of these entities and/or attributes. As will be described herein by way of example, and not as a limitation, the user interface may be configured to display five stars that are selectable to express the user's rating, with a five-star selection indicating a most favorable rating and a one-star selection indicating a least favorable rating. It should be understood that any rating system and/or way to present such a rating system is included in this disclosure. The use of stars, a given rating scale, or types of rating input mechanisms are not described herein as limitations of how the ratings may be provided by the entities. The request data may also cause display of one or more specific questions to which answers are solicited by the aviation-based entity rating system. The questions may be specific to the entities type (e.g., traveler, broker, etc.), the flight at issue, the specific entity at issue, etc.

Additionally, or alternatively, the request data may include an ability for the entity to provide open-ended comments or in other words provide user input that is not in response to a specific question. Text data representing these comments may be received by the remote system and may be analyzed to determine what specific questions may be asked for subsequent ratings. For example, one or more machine learning models may be generated and trained based at least in part on the text data from multiple comments received over time by the aviation-based entity rating platform. In these examples, the machine learning models may be configured to identify trends in comments, and a question generator of the remote system may be configured to develop questions to pose to entities based on those trends. For example, if comments frequently include mention of poor food quality, the machine learning model may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc.

At block 708, the process 700 may include receiving user input data corresponding to the rating user input. For example, the entities may utilize the user interfaces described herein to provide user input representing the requested rating information, including selection of a rating for given attributes of the flight, answers to specific questions, and/or input of comments as described herein. This rating information may be sent from the devices associated with the entities to the remote system.

At block 710, the process 700 may include generating flight data indicating one or more characteristics associated with the scheduled flight as completed. For example, a flight data generator of the remote system may be configured to generate flight data associated with aerial vehicle flights, which may be utilized by the rating component to generate the rating data. For example, the flight data may include attributes associated with the flight itself, such as a departure time of the flight, an arrival time of the flight, a number of crew members for the flight, any issues experienced with the flight, an age of the aerial vehicle, and/or any other attributes of the flight itself. This information may be utilized to influence ratings associated with the flight and/or one or more entities associated with the flight. For example, even when user rating information does not indicate frequent late departure of a flight, if the flight data does provide such an indication, the rating of the timeliness of the flight may be negatively impacted by the flight data.

At block 712, the process 700 may include generating rating data, the rating data generated based at least in part on the user input data and the flight data, the rating data including: a first rating of the aerial vehicle; a second rating of the aerial vehicle operator; a third rating of the aerial vehicle flight broker; and a fourth rating of the aerial vehicle traveler. For example, a rating component of the remote system may be configured to receive the rating information and to generate rating data based at least in part on the rating information. The rating data may associate a rating with the one or more attributes of the flights, such as over time. For example, rating information on the cleanliness of a given aerial vehicle may be receive by multiple travelers over multiple flights over time. The rating information may be utilized to generate an overall rating for the cleanliness of the aerial vehicle, which may impact a rating for the aerial vehicle itself. In these and other examples, the rating component may be configured to weight or otherwise implement one or more factors to generate a rating that considers the rating information that is received. For example, certain rating information received closest in time may be weighted more heavily (e.g., may impact the rating more) than rating information received years ago, particularly with respect to attributes that are likely to degrade over time, such as aerial vehicle cleanliness, newness, etc. Additional factors may be utilized to determine how to weight ratings, such as whether the rating information was received from a frequent traveler, whether the rating information was consistent or inconsistent with rating information received by other travelers on the same flight, etc. Additionally, the weighting of ratings as described herein may be performed dynamically and specifically for a given entity to which the ratings are to be displayed. For example, for a given traveler, that traveler may have provided user input associated with user preferences, which may indicate that the traveler places more importance on on-time departure than flight amenities. In these examples, the rating information may be weighted differently from another traveler with user preferences that indicate flight amenities are more important to that traveler than on-time departures. In this example, when the first traveler is presented with ratings on flights, for example, a rating for a flight and/or operator may be weighted such that ratings associated with departure timeliness are more heavily weighted than ratings associated with amenities. As such, the rating displayed for a given flight, attribute of a flight, and/or entities associated with a flight may change not only based on the rating information received by raters, but also based at least in part on the user profile associated with viewing the ratings.

The rating component may also be configured to aggregate ratings such that an overall rating is generated for a flight and/or aspects associated with a flight. For example, rating information may be received for aircraft cleanliness, expected amenities, and comfort. This rating information may be aggregated to provide an aggregate rating for the aircraft. This same aggregation process may be performed for one or more other aspects associated with a flight, such as ratings for the crew, ratings for the broker, ratings for the services provided, etc. It should be understood that while several examples provided herein are associated with rating the flight and attributes of the flight, ratings may also be provided for travelers. For example, user interfaces associated with the brokers, operators, crew, etc. may be caused to display requests for rating information associated with the travelers of a flight. Ratings may be generated for individual travelers and may be utilized by the remote system as described herein.

At block 714, the process 700 may include storing the rating data in a database of the aviation-based user platform. For example, the rating data may be stored such that it may be queried and provided when requested.

Additionally, or alternatively, the process 700 may include receiving request data for use of the aerial vehicle. The process 700 may also include querying the database of the aviation-based user platform for the rating data utilizing an identifier of the aerial vehicle. The process 700 may also include receiving the rating data from the database and generating an aggregated rating for entities associated with the aerial vehicle, the aggregated rating based at least in part on the first rating, the second rating, and the third rating. The process 700 may also include causing a user interface to display the aggregated rating in response to the request data.

Additionally, or alternatively, the process 700 may include receiving user preference data indicating importance of one or more characteristics associated with use of the aerial vehicle by a traveler requesting use of the aerial vehicle, the one or more characteristics including aerial vehicle cleanliness, departure punctuality, ease of flight booking, departure location, flight amenities, and aerial vehicle type. The process 700 may also include receiving the rating data from the database. The process 700 may also include generating weighted rating data based at least in part on the user preference data, the weighting rating data increasing or decreasing at least one of the first rating, the second rating, or the third rating based at least in part on the importance of the one or more characteristics as indicated by the user preference data. The process 700 may also include causing display of ratings based at least in part on the weighted rating data instead of the rating data.

Additionally, or alternatively, the process 700 may include receiving request data for use of the aerial vehicle by a requesting traveler. The process 700 may also include determining an identifier of the requesting traveler based at least in part on the request data. The process 700 may also include querying the database of the aviation-based user platform for a traveler rating associated with the identifier of the requesting traveler and receiving, from the database, data representing the traveler rating. The process 700 may also include sending, to a device associated with at least one of the aerial vehicle operator or the aerial vehicle owner, the data representing the traveler rating along with a request for confirming acceptance of the use of the aerial vehicle by the requesting traveler. The process 700 may also include receiving, from the device, response data indicating acceptance of the use of the aerial vehicle by the requesting traveler having the traveler rating.

FIG. 8 illustrates a flow diagram of another example process 800 for utilizing an aviation-based entity rating platform. The order in which the operations or steps are described is not intended to be construed as a limitation, and any number of the described operations may be combined in any order and/or in parallel to implement process 800.

At block 802, the process 800 may include determining that a scheduled flight on an aerial vehicle has been completed, the scheduled flight associated with an aerial vehicle owner, an aerial vehicle operator, an aerial vehicle flight broker, and an aerial vehicle traveler. For example, rating triggering events may include occurrence of a scheduled departure time, an indication that the flight has initiated, an indication that the flight has been completed, lapsing of the given time frame for scheduled use of the aerial vehicle, lapsing of a period of time after the flight has been completed, receipt of payment associated with the scheduled flight, and/or one or more other events where one or more of the entities may be willing to providing rating information. One or more machine learning models may be utilized to determine a likelihood that a request for rating information will be accepted in response to given rating triggering events and may be configured to determine which rating triggering events are most likely to be accepted. These machine learning models may be trained utilizing historical rating information and acceptance of past requests for rating information.

At block 804, the process 800 may include requesting rating user input from the aerial vehicle operator, the aerial vehicle flight broker, and the aerial vehicle traveler. For example, when a rating triggering event occurs, a request component of the remote system may be configured to generate and send request data for the rating information. The request data may identify the flight at issue and details associated with the flight, such as the aerial vehicle, broker, operator, traveler(s), owner, and/or any other attributes of the flight. The request data may also cause a user interface to be displayed on one or more devices associated with the entities. The user interface may display, for example, text requesting that the entity provide rating information. In instances where the entity provides user input indicating acceptance of the request to provide rating information, the user interface may display functionality for requesting and receiving user input for rating one or more of the attributes of the flight. For example, request data sent to a traveler device associated with a traveler of the flight may indicate the aerial vehicle, broker, operator, crew, and/or services associated with the flight. The user interface may be configured to receive user input data indicating the traveler's subjective rating of one or more of these entities and/or attributes. As will be described herein by way of example, and not as a limitation, the user interface may be configured to display five stars that are selectable to express the user's rating, with a five-star selection indicating a most favorable rating and a one-star selection indicating a least favorable rating. It should be understood that any rating system and/or way to present such a rating system is included in this disclosure. The use of stars, a given rating scale, or types of rating input mechanisms are not described herein as limitations of how the ratings may be provided by the entities. The request data may also cause display of one or more specific questions to which answers are solicited by the aviation-based entity rating system. The questions may be specific to the entities type (e.g., traveler, broker, etc.), the flight at issue, the specific entity at issue, etc.

Additionally, or alternatively, the request data may include an ability for the entity to provide open-ended comments or in other words provide user input that is not in response to a specific question. Text data representing these comments may be received by the remote system and may be analyzed to determine what specific questions may be asked for subsequent ratings. For example, one or more machine learning models may be generated and trained based at least in part on the text data from multiple comments received over time by the aviation-based entity rating platform. In these examples, the machine learning models may be configured to identify trends in comments, and a question generator of the remote system may be configured to develop questions to pose to entities based on those trends. For example, if comments frequently include mention of poor food quality, the machine learning model may be configured to identify that trend, determine the food service provider associated with the flights corresponding to the comments, determine that the same food service provider was associated with the flights and/or a threshold number of the flights, and develop one or more questions to pose to travelers about the food quality associated with that given food service provider. In other examples, analysis of the comments as described herein may be utilized for one or more other purposes, such as the generation of recommendations, the weighting and/or aggregating of ratings, etc.

At block 806, the process 800 may include receiving user input data corresponding to the rating user input. For example, the entities may utilize the user interfaces described herein to provide user input representing the requested rating information, including selection of a rating for given attributes of the flight, answers to specific questions, and/or input of comments as described herein. This rating information may be sent from the devices associated with the entities to the remote system.

At block 808, the process 800 may include generating flight data indicating one or more characteristics associated with the scheduled flight as completed. For example, a flight data generator of the remote system may be configured to generate flight data associated with aerial vehicle flights, which may be utilized by the rating component to generate the rating data. For example, the flight data may include attributes associated with the flight itself, such as a departure time of the flight, an arrival time of the flight, a number of crew members for the flight, any issues experienced with the flight, an age of the aerial vehicle, and/or any other attributes of the flight itself. This information may be utilized to influence ratings associated with the flight and/or one or more entities associated with the flight. For example, even when user rating information does not indicate frequent late departure of a flight, if the flight data does provide such an indication, the rating of the timeliness of the flight may be negatively impacted by the flight data.

At block 810, the process 800 may include generating rating data, the rating data generated based at least in part on the user input data and the flight data, the rating data including: a first rating of the aerial vehicle operator; a second rating of the aerial vehicle flight broker; and a third rating of the aerial vehicle traveler. For example, a rating component of the remote system may be configured to receive the rating information and to generate rating data based at least in part on the rating information. The rating data may associate a rating with the one or more attributes of the flights, such as over time. For example, rating information on the cleanliness of a given aerial vehicle may be receive by multiple travelers over multiple flights over time. The rating information may be utilized to generate an overall rating for the cleanliness of the aerial vehicle, which may impact a rating for the aerial vehicle itself. In these and other examples, the rating component may be configured to weight or otherwise implement one or more factors to generate a rating that considers the rating information that is received. For example, certain rating information received closest in time may be weighted more heavily (e.g., may impact the rating more) than rating information received years ago, particularly with respect to attributes that are likely to degrade over time, such as aerial vehicle cleanliness, newness, etc. Additional factors may be utilized to determine how to weight ratings, such as whether the rating information was received from a frequent traveler, whether the rating information was consistent or inconsistent with rating information received by other travelers on the same flight, etc. Additionally, the weighting of ratings as described herein may be performed dynamically and specifically for a given entity to which the ratings are to be displayed. For example, for a given traveler, that traveler may have provided user input associated with user preferences, which may indicate that the traveler places more importance on on-time departure than flight amenities. In these examples, the rating information may be weighted differently from another traveler with user preferences that indicate flight amenities are more important to that traveler than on-time departures. In this example, when the first traveler is presented with ratings on flights, for example, a rating for a flight and/or operator may be weighted such that ratings associated with departure timeliness are more heavily weighted than ratings associated with amenities. As such, the rating displayed for a given flight, attribute of a flight, and/or entities associated with a flight may change not only based on the rating information received by raters, but also based at least in part on the user profile associated with viewing the ratings.

The rating component may also be configured to aggregate ratings such that an overall rating is generated for a flight and/or aspects associated with a flight. For example, rating information may be received for aircraft cleanliness, expected amenities, and comfort. This rating information may be aggregated to provide an aggregate rating for the aircraft. This same aggregation process may be performed for one or more other aspects associated with a flight, such as ratings for the crew, ratings for the broker, ratings for the services provided, etc. It should be understood that while several examples provided herein are associated with rating the flight and attributes of the flight, ratings may also be provided for travelers. For example, user interfaces associated with the brokers, operators, crew, etc. may be caused to display requests for rating information associated with the travelers of a flight. Ratings may be generated for individual travelers and may be utilized by the remote system as described herein.

Additionally, or alternatively, the process 800 may include generating an aggregated rating for entities associated with the aerial vehicle, the aggregated rating based at least in part on the first rating and the second rating. The process 800 may also include causing a user interface to display the aggregated rating in response to request data for information associated with the aerial vehicle.

Additionally, or alternatively, the process 800 may include receiving user preference data indicating importance of one or more characteristics associated with use of the aerial vehicle by a traveler requesting use of the aerial vehicle. The process 800 may also include generating weighted rating data based at least in part on the user preference data, the weighting rating data increasing or decreasing at least one of the first rating or the second rating based at least in part on the importance of the one or more characteristics as indicated by the user preference data. The process 800 may also include causing display of ratings based at least in part on the weighted rating data instead of the rating data.

Additionally, or alternatively, the process 800 may include receiving request data for use of the aerial vehicle by a requesting traveler. The process 800 may also include determining data representing a traveler rating of the requesting traveler. The process 800 may also include sending, to a device associated with at least one of the aerial vehicle operator or the aerial vehicle owner, the data representing the traveler rating along with a request for confirming acceptance of use of the aerial vehicle by the requesting traveler. The process 800 may also include receiving, from the device, response data indicating acceptance of the use of the aerial vehicle by the requesting traveler having the traveler rating.

Additionally, or alternatively, the process 800 may include determining, utilizing natural language understanding processing, a subject associated with the comments. The process 800 may also include determining, based at least in part on prior user input data including prior comments, that the subject is associated with the comments and the prior comments at least a threshold number of times. The process 800 may also include generating data representing a rating question based at least in part on the subject and determining that the subject is associated with the comments and the prior comments the at least the threshold number of times. In these examples, requesting the rating user input may include requesting a response to the rating question.

Additionally, or alternatively, the process 800 may include receiving user preference data indicating importance of one or more characteristics associated with use of the aerial vehicle by a traveler requesting use of the aerial vehicle. The process 800 may also include determining flights with ratings associated with the one or more characteristics that satisfy a threshold rating. The process 800 may also include causing display of the flights to be prioritized over other flights.

Additionally, or alternatively, the process 800 may include determining a recommended price to associate with use of the aerial vehicle based at least in part on the first rating and the second rating, the recommended price determined utilizing a model configured to determine recommended prices by analyzing ratings associated with a given aerial vehicle as compared to reference ratings associated with aerial vehicles of a same aerial vehicle type as the given aerial vehicle. The process 800 may also include causing display of the recommended price on a device associated with at least one of the aerial vehicle operator or the aerial vehicle owner.

Additionally, or alternatively, the process 800 may include determining that the first rating and the second rating satisfy a threshold rating. The process 800 may also include, based at least in part on the first rating and the second rating satisfying the threshold rating, enabling auto-booking functionality for flights associated with the aerial vehicle operator and the aerial vehicle flight broker.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system, comprising:
one or more processors; and
non-transitory computer-readable media storing computer-executable instructions that, when executed by the one or more processors, cause the one or more processors to perform operations comprising:
generating an aviation-based user platform configured to receive input from devices associated with aerial vehicle owners, devices associated with aerial vehicle operators, devices associated with aerial vehicle flight brokers, and devices associated with aerial vehicle travelers;
determining that a scheduled flight on an aerial vehicle has been completed, the scheduled flight associated with an aerial vehicle owner of the aerial vehicle owners, an aerial vehicle operator of the aerial vehicle operators, an aerial vehicle flight broker of the aerial vehicle flight brokers, and an aerial vehicle traveler of the aerial vehicle travelers;
causing user interfaces to be displayed requesting rating user input from the aerial vehicle owner, the aerial vehicle operator, the aerial vehicle flight broker, and the aerial vehicle traveler;
receiving user input data corresponding to the rating user input;
generating flight data indicating one or more characteristics associated with the scheduled flight as completed;
generating rating data, the rating data generated based at least in part on the user input data and the flight data, the rating data including:
a first rating of the aerial vehicle;
a second rating of the aerial vehicle operator;
a third rating of the aerial vehicle flight broker; and
a fourth rating of the aerial vehicle traveler; and
storing the rating data in a database of the aviation-based user platform.

2. The system of claim 1, the operations further comprising:
receiving request data for use of the aerial vehicle;
querying the database of the aviation-based user platform for the rating data utilizing an identifier of the aerial vehicle;
receiving the rating data from the database;
generating an aggregated rating for entities associated with the aerial vehicle, the aggregated rating based at least in part on the first rating, the second rating, and the third rating; and
causing a user interface to display the aggregated rating in response to the request data.

3. The system of claim 1, the operations further comprising:
receiving user preference data indicating importance of one or more characteristics associated with use of the aerial vehicle by a traveler requesting use of the aerial vehicle, the one or more characteristics including aerial vehicle cleanliness, departure punctuality, ease of flight booking, departure location, flight amenities, and aerial vehicle type;
receiving the rating data from the database;
generating weighted rating data based at least in part on the user preference data, the weighting rating data increasing or decreasing at least one of the first rating, the second rating, or the third rating based at least in part on the importance of the one or more characteristics as indicated by the user preference data; and
causing display of ratings based at least in part on the weighted rating data instead of the rating data.

4. The system of claim 1, the operations further comprising:
receiving request data for use of the aerial vehicle by a requesting traveler;
determining an identifier of the requesting traveler based at least in part on the request data;
querying the database of the aviation-based user platform for a traveler rating associated with the identifier of the requesting traveler;
receiving, from the database, data representing the traveler rating;
sending, to a device associated with at least one of the aerial vehicle operator or the aerial vehicle owner, the data representing the traveler rating along with a request for confirming acceptance of the use of the aerial vehicle by the requesting traveler; and
receiving, from the device, response data indicating acceptance of the use of the aerial vehicle by the requesting traveler having the traveler rating.

5. A method, comprising:
determining that a scheduled flight on an aerial vehicle has been completed, the scheduled flight associated with an aerial vehicle owner, an aerial vehicle operator, an aerial vehicle flight broker, and an aerial vehicle traveler;
requesting rating user input from the aerial vehicle operator, the aerial vehicle flight broker, and the aerial vehicle traveler;
receiving user input data corresponding to the rating user input;
generating flight data indicating one or more characteristics associated with the scheduled flight as completed; and
generating rating data, the rating data generated based at least in part on the user input data and the flight data, the rating data including:
a first rating of the aerial vehicle operator;
a second rating of the aerial vehicle flight broker; and
a third rating of the aerial vehicle traveler.

6. The method of claim 5, further comprising:
generating an aggregated rating for entities associated with the aerial vehicle, the aggregated rating based at least in part on the first rating and the second rating; and
causing a user interface to display the aggregated rating in response to request data for information associated with the aerial vehicle.

7. The method of claim 5, further comprising:
receiving user preference data indicating importance of one or more characteristics associated with use of the aerial vehicle by a traveler requesting use of the aerial vehicle;
generating weighted rating data based at least in part on the user preference data, the weighting rating data increasing or decreasing at least one of the first rating or the second rating based at least in part on the importance of the one or more characteristics as indicated by the user preference data; and
causing display of ratings based at least in part on the weighted rating data instead of the rating data.

8. The method of claim 5, further comprising:
receiving request data for use of the aerial vehicle by a requesting traveler;
determining data representing a traveler rating of the requesting traveler;
sending, to a device associated with at least one of the aerial vehicle operator or the aerial vehicle owner, the data representing the traveler rating along with a request for confirming acceptance of use of the aerial vehicle by the requesting traveler; and
receiving, from the device, response data indicating acceptance of the use of the aerial vehicle by the requesting traveler having the traveler rating.

9. The method of claim 5, wherein the user input data includes text data representing comments, and the method further comprises:
determining, utilizing natural language understanding processing, a subject associated with the comments;
determining, based at least in part on prior user input data including prior comments, that the subject is associated with the comments and the prior comments at least a threshold number of times;
generating data representing a rating question based at least in part on the subject and determining that the subject is associated with the comments and the prior comments the at least the threshold number of times; and
wherein requesting the rating user input comprises requesting a response to the rating question.

10. The method of claim 5, further comprising:
receiving user preference data indicating importance of one or more characteristics associated with use of the aerial vehicle by a traveler requesting use of the aerial vehicle;
determining flights with ratings associated with the one or more characteristics that satisfy a threshold rating; and
causing display of the flights to be prioritized over other flights.

11. The method of claim 5, further comprising:
determining a recommended price to associate with use of the aerial vehicle based at least in part on the first rating and the second rating, the recommended price determined utilizing a model configured to determine recommended prices by analyzing ratings associated with a given aerial vehicle as compared to reference ratings associated with aerial vehicles of a same aerial vehicle type as the given aerial vehicle; and
causing display of the recommended price on a device associated with at least one of the aerial vehicle operator or the aerial vehicle owner.

12. The method of claim 5, further comprising:
determining that the first rating and the second rating satisfy a threshold rating; and
based at least in part on the first rating and the second rating satisfying the threshold rating, enabling auto-booking functionality for flights associated with the aerial vehicle operator and the aerial vehicle flight broker.

13. A system, comprising:
one or more processors; and
non-transitory computer-readable media storing computer-executable instructions that, when executed by the one or more processors, cause the one or more processors to perform operations comprising:
determining that a scheduled flight on an aerial vehicle has been completed, the scheduled flight associated with an aerial vehicle owner, an aerial vehicle operator, an aerial vehicle flight broker, and an aerial vehicle traveler;
requesting rating user input from the aerial vehicle operator, the aerial vehicle flight broker, and the aerial vehicle traveler;
receiving user input data corresponding to the rating user input;
generating flight data indicating one or more characteristics associated with the scheduled flight as completed; and
generating rating data, the rating data generated based at least in part on the user input data and the flight data, the rating data including:
a first rating of the aerial vehicle operator;
a second rating of the aerial vehicle flight broker; and
a third rating of the aerial vehicle traveler.

14. The system of claim 13, the operations further comprising:
generating an aggregated rating for entities associated with the aerial vehicle, the aggregated rating based at least in part on the first rating and the second rating; and
causing a user interface to display the aggregated rating in response to request data for information associated with the aerial vehicle.

15. The system of claim 13, the operations further comprising:
receiving user preference data indicating importance of one or more characteristics associated with use of the aerial vehicle by a traveler requesting use of the aerial vehicle;
generating weighted rating data based at least in part on the user preference data, the weighting rating data increasing or decreasing at least one of the first rating or the second rating based at least in part on the importance of the one or more characteristics as indicated by the user preference data; and
causing display of ratings based at least in part on the weighted rating data instead of the rating data.

16. The system of claim 13, the operations further comprising:
receiving request data for use of the aerial vehicle by a requesting traveler;
determining data representing a traveler rating of the requesting traveler;
sending, to a device associated with at least one of the aerial vehicle operator or the aerial vehicle owner, the data representing the traveler rating along with a request for confirming acceptance of use of the aerial vehicle by the requesting traveler; and
receiving, from the device, response data indicating acceptance of the use of the aerial vehicle by the requesting traveler having the traveler rating.

17. The system of claim 13, wherein the user input data includes text data representing comments, and the operations further comprise:
determining, utilizing natural language understanding processing, a subject associated with the comments;
determining, based at least in part on prior user input data including prior comments, that the subject is associated with the comments and the prior comments at least a threshold number of times;
generating data representing a rating question based at least in part on the subject and determining that the subject is associated with the comments and the prior comments the at least the threshold number of times; and
wherein requesting the rating user input comprises requesting a response to the rating question.

18. The system of claim 13, the operations further comprising:
receiving user preference data indicating importance of one or more characteristics associated with use of the aerial vehicle by a traveler requesting use of the aerial vehicle;
determining flights with ratings associated with the one or more characteristics that satisfy a threshold rating; and
causing display of the flights to be prioritized over other flights.

19. The system of claim 13, the operations further comprising:
determining a recommended price to associate with use of the aerial vehicle based at least in part on the first rating and the second rating, the recommended price determined utilizing a model configured to determine recommended prices by analyzing ratings associated with a given aerial vehicle as compared to reference ratings associated with aerial vehicles of a same aerial vehicle type as the given aerial vehicle; and
causing display of the recommended price on a device associated with at least one of the aerial vehicle operator or the aerial vehicle owner.

20. The system of claim 13, the operations further comprising:
determining that the first rating and the second rating satisfy a threshold rating; and
based at least in part on the first rating and the second rating satisfying the threshold rating, enabling auto-booking functionality for flights associated with the aerial vehicle operator and the aerial vehicle flight broker.
